(19) United States
(12) Patent Application Publication
(10) Pub. No.: US 2019/0358796 A1
(43) Pub. Date: Nov. 28, 2019

(54) REPAIR TOOL FOR DRUM BRAKE

(71) Applicant: PI-LIANG WU, Taichung (TW)

(72) Inventor: PI-LIANG WU, Taichung (TW)

(21) Appl. No.: 16/177,439

(22) Filed: Nov. 1, 2018

(30) Foreign Application Priority Data
May 24, 2018 (TW) 107117829

(51) Int. Cl. B25B 27/00

(52) U.S. Cl. CPC B25B 27/0035

(57) ABSTRACT

A repair tool for a drum brake contains: a base, a first engagement member, a second engagement member, and a screw rod. The first engagement member is connected with the base, the second engagement member is movably fixed in the base, and the screw rod is rotatably connected with the first engagement member and the second engagement member. The first engagement member includes a first raised portion, a first extension, and a first locking portion, wherein the first locking portion has a first groove and a first notch. The second engagement member includes a second raised portion, a second extension, and a second locking portion, wherein the second locking portion has a second groove and a second notch. The screw rod inserts through the second raised portion and includes a coupling stem and a rotatable portion connected with the coupling stem and located outside the base.

### FIELD OF THE INVENTION

The present invention relates to a repair tool for a drum brake which is capable of repairing or replacing the brake cylinder easily without removing the two brake shoes.

### BACKGROUND OF THE INVENTION

A drum brake is mounted on a rear wheel of a vehicle so as to brake the wheel stably.

The drum brake contains a bottom plate, a brake cylinder, two brake shoes, a brake drum, and other transmission parts. The two brake shoes are symmetrically fixed in the brake drum, an end of each of the two brake shoes is moved into the brake cylinder, and two pulling springs are connected with the two brake shoes respectively. When the drum brake operates, a fluid pressure of the brake cylinder pushes the two brake shoes outward so that two brake linings of the two brake shoes make friction with the brake drum which rotates with the wheel, thus stopping the wheel. After releasing the wheel, the fluid pressure in the brake cylinder disappears so that the two pulling springs pull the two brake shoes to return two original positions respectively.

After the two brake linings make friction with the brake drum, chips of the brake linings are moved into the brake cylinder by the two brake shoes easily, thus reducing friction force of the two brake shoes.

It is essential to remove the brake drum before repairing or replacing the brake cylinder so as to expose the two brake shoes outside the brake cylinder. Furthermore, the two brake shoes are removable after detaching the two pulling springs so as to take the brake cylinder outside the bottom plate.

After repairing or replacing the brake cylinder, the brake cylinder or a new brake cylinder is mounted on the bottom plate and is connected with a brake hose, the two brake shoes are fixed, and the two pulling springs are coupled with the two brake shoes respectively, thus repairing or replacing the brake cylinder troublesomely.

The present invention has arisen to mitigate and/or obviate the afore-described disadvantages.

### SUMMARY OF THE INVENTION

The primary objective of the present invention is to provide a repair tool for a drum brake which is capable of repairing or replacing the brake cylinder easily without removing the two brake shoes.

To obtain the above objective, a repair tool for a drum brake provided by the present invention contains: a base formed in an elongated frame, a first engagement member, a second engagement member, and a screw rod.

The first engagement member is connected with the base, the second engagement member is movably fixed in the base opposite to the first engagement, a first end of the screw rod is rotatably connected with the first engagement member, and a second end of the screw rod is screwed with the second engagement member.

The first engagement member includes a first raised portion, a first extension, and a first locking portion, wherein the first raised portion is adjacent to the elongated slot and is connected with the first plate and the second plate, a first end of the first extension is coupled with a bottom of the first raised portion, a second end of the first extension extends downward to connect with a first end of the first locking portion, and a second end of the first locking portion extends away from the first extension, wherein the first locking portion has a first groove defined on a surface thereof away from the elongated slot, and the first locking portion has a first notch defined on a bottom thereof, wherein a top of the first notch extends to the first notch.

The second engagement member includes a second raised portion, a second extension, and a second locking portion, wherein the second raised portion is accommodated in the elongated slot, a first end of the second extension is coupled with a bottom of the second raised portion, a second end of the second extension extends downward to connect with a first end of the second locking portion, and a second end of the second locking portion extends away from the second extension, wherein the second locking portion has a second groove defined on a surface thereof away from the elongated slot, the second locking portion has a second notch defined on a bottom thereof, and a top of the second notch extends to the second.

The screw rod inserts through the second raised portion and includes a coupling stem extending from an end thereof and rotatably connected with the first raised portion, wherein the screw rod further includes a rotatable portion connected with the coupling stem and located outside the base.

### BRIEF DESCRIPTION OF THE DRAWINGS

FIG. 1 is a perspective view showing the assembly of a repair tool for a drum brake to a preferred embodiment of the present invention,

FIG. 2 is a perspective view showing the exploded components of the repair tool for the drum brake according to the preferred embodiment of the present invention,

FIG. 3 is a perspective view showing the assembly of a brake shoe according to the preferred embodiment of the present invention, and

FIG. 4 is a cross sectional view showing the operation of the repair tool for the drum brake according to the preferred embodiment of the present invention.

### DETAILED DESCRIPTION OF THE PREFERRED EMBODIMENTS

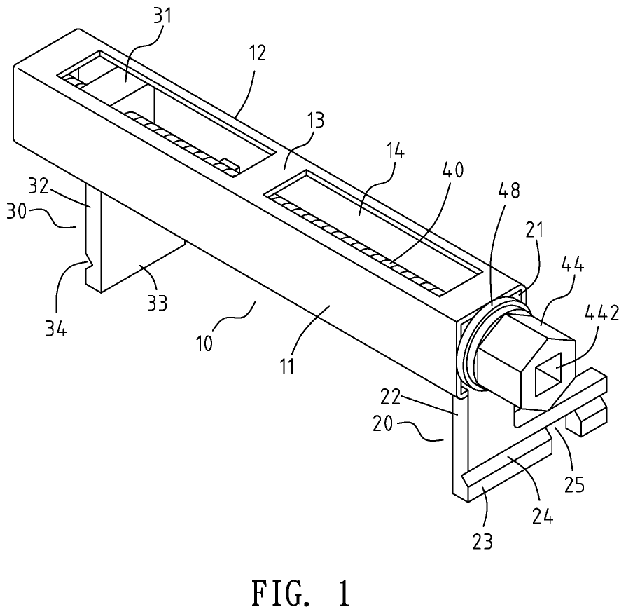

With reference to FIG. 1, a repair tool for a drum brake according to a preferred embodiment of the present invention comprises: a base 10, a first engagement member 20, a second engagement member 30, and a screw rod 40.

The base 10 is hollow and is formed in an elongated frame shape, and the first engagement member 20 is connected with the base 10. The second engagement member 30 is movably fixed in the base 10 opposite to the first engagement 20. A first end of the screw rod 40 is rotatably connected with the first engagement member 20, and a second end of the screw rod 40 is screwed with the second engagement member 30, such that when the screw rod 40 rotates, the second engagement member 30 linearly moves along the screw rod 40 so as to change a distance between the first engagement member 20 and the second engagement member 30.

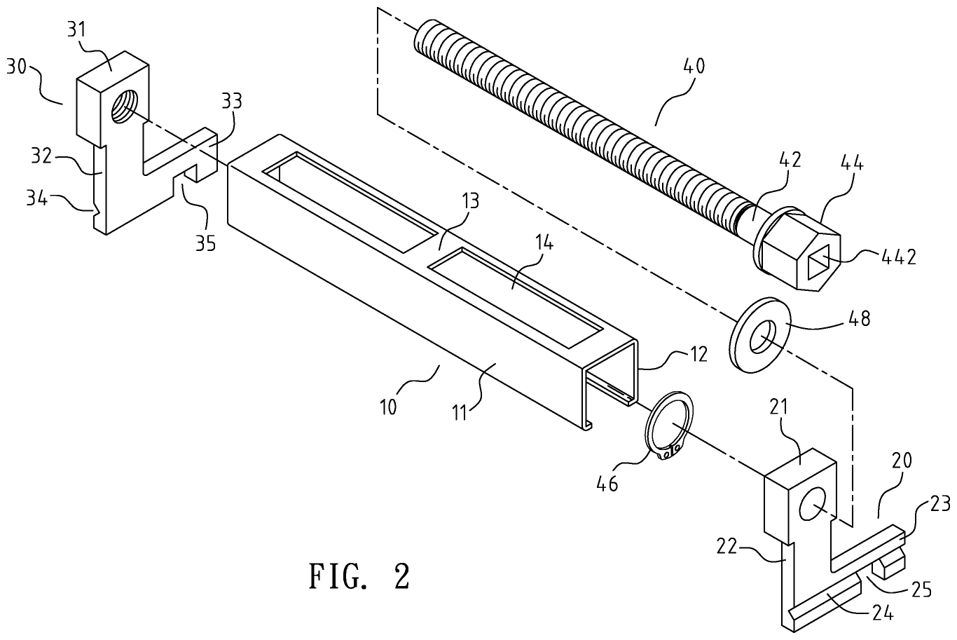

Referring to FIGS. 1 and 2, the base 10 includes a first plate 11, a second plate 12, and at least one connection sheet 13. The first and second plates 11, 12 are elongated, and the first plate 11 is parallelly opposite to the second plate 12, wherein the connection sheet 13 is in connection with the first plate 11 and the second plate 12, and the base 10 further includes an elongated slot 14 defined between the first plate 11 and the second plate 12.

The first engagement member 20 includes a first raised portion 21, a first extension 22, and a first locking portion 23, wherein the first raised portion 21 is adjacent to the elongated slot 14 and is connected with the first plate 11 and the second plate 12. A first end of the first extension 22 is coupled with a bottom of the first raised portion 21, a second end of the first extension 22 extends downward to connect with a first end of the first locking portion 23, and a second end of the first locking portion 23 extends away from the first extension 22, wherein the first locking portion 23 is perpendicular to the first extension 22. The first locking portion 23 has a first groove 24 defined on a surface thereof away from the elongated slot 14, wherein two ends of the first groove 24 extend along the first and second ends of the first locking portion 23 respectively, the first locking portion 23 has a first notch 25 defined on a bottom thereof, and a top of the first notch 25 extends to the first notch 24.

The second engagement member 30 includes a second raised portion 31, a second extension 32, and a second locking portion 33, wherein the second raised portion 31 is accommodated in the elongated slot 14. A first end of the second extension 32 is coupled with a bottom of the second raised portion 31, a second end of the second extension 32 extends downward to connect with a first end of the second locking portion 33, and a second end of the second locking portion 33 extends away from the second extension 32, wherein the second locking portion 33 is perpendicular to the second extension 32. The second locking portion 33 has a second groove 34 defined on a surface thereof away from the elongated slot 14, wherein two ends of the second groove 34 extend along the first and second ends of the second locking portion 33 respectively, the second locking portion 33 has a second notch 35 defined on a bottom thereof, and a top of the second notch 35 extends to the second notch 34. The second extension 32 is symmetrical to the first extension 22, and the second locking portion 33 is symmetrical to the first locking portion 23.

The screw rod 40 is accommodated in the elongated slot 14 and inserts through the second raised portion 31 so as to drive the second engagement member 30 to move reciprocatingly. The screw rod 40 includes a coupling stem 42 extending from an end thereof and rotatably connected with the first raised portion 21, a rotatable portion 44 connected with the coupling stem 42 and located outside the base 10, wherein the rotatable portion 44 is polygonal (i.e., hexagonal) and has a polygonal (i.e., quadrilateral) orifice 442 defined in a center of a distal end of the rotatable portion 44, and the rotatable portion 44 is engaged with and is rotated by a wrench or other hand tools so as to drive the screw rod 40 to revolve. The coupling stem 42 is retained with a fastening ring 46 proximate to the first raised portion 21, and a washer 48 is rotatably connected on the coupling stem 42 between the first raised portion 21 and the rotatable portion 44, such that the coupling stem 42 is rotatably coupled with the first raised portion 21 by ways of the fastening ring 46 and the washer 48.

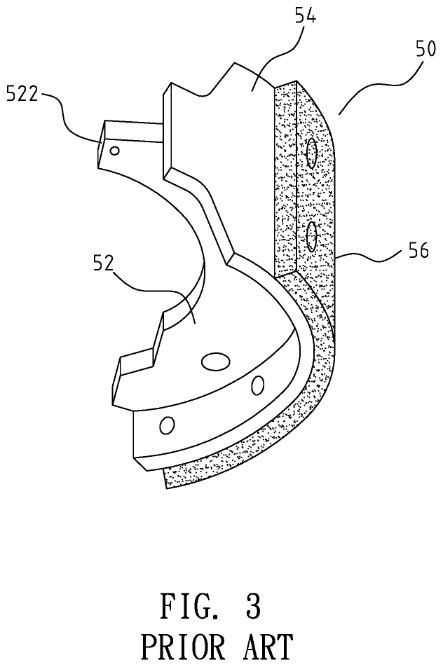

As shown in FIG. 3, a brake shoe 50 is comprised of a support sheet 52 and a wing sheet 54 which are arcuate, wherein an arcuately outer rim of the support sheet 52 is vertically connected with an arcuately inner rim of the wing sheet 54 which abuts against a brake lining 56, and the support sheet 52 has a projection 522 extending from an end thereof and an arcuate inner rim of the wing sheet 54 so that the projection 522 moves into a brake cylinder (not shown) to be pushed by the brake cylinder.

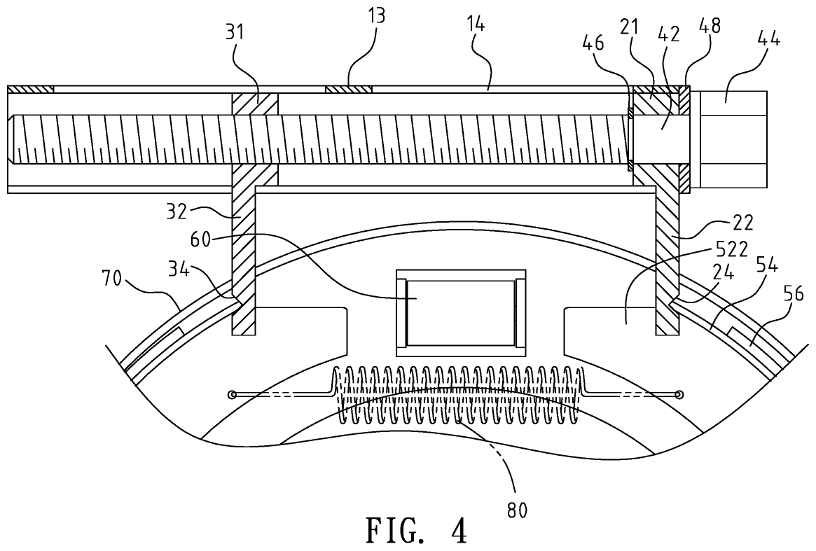

As shown in FIGS. 1-4, when repairing or replacing the brake cylinder 60, the brake cylinder 60 is removed from a bottom plate 70, wherein when two brake shoes 50 are not detachable from the bottom plate 70 beforehand, the first locking portion 23 and the second locking portion 33 move into two ends of the brake cylinder 60 respectively so that two wing sheets 54 of the two brake shoes 50 engage into the first notch 24 and the second notch 34 individually, and the first notch 25 and the second notch 35 accommodate two projections 522 of the two brake shoes 50 respectively. Thereafter, the screw rod 40 is rotated to drive the second engagement member 30 to move away from the first engagement member 20, such that the two brake shoes 50 are pushed by the second engagement member 30 to move reversely. After the two projections 522 of the two brake shoes 50 remove from the brake cylinder 60, the brake cylinder 60 is removed from the bottom plate 70.

After repairing the brake cylinder 60 or replacing a new brake cylinder 60 onto the bottom plate 70, the screw rod 40 is rotated reversely so that the second engagement member 30 moves to the first engagement member 20, and a pulling spring 80 pulls the two brake shoes 50 to move oppositely so that the two projections 522 of the two brake shoes 50 move into the brake cylinder 60 individually, thus repairing or replacing the brake cylinder 60.

Accordingly, the repair tool is capable of repairing or replacing the brake cylinder 60 easily without removing the two brake shoes 50. Preferably, the second end of the first extension 22 extends downward to connect with the first end of the first locking portion 23, and the second end of the second extension 32 extends downward to connect with the first end of the second locking portion 33, wherein the base 10 is separated from the brake cylinder 60 in a direction vertical to a front end of the bottom plate 70 so as to avoid interfering the brake cylinder 60.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention

What is claimed is:

1. A repair tool for a drum brake comprising:
a base formed in an elongated frame, a first engagement member, a second engagement member, and a screw rod;
wherein the first engagement member is connected with the base, the second engagement member is movably fixed in the base opposite to the first engagement, a first end of the screw rod is rotatably connected with the first engagement member, and a second end of the screw rod is screwed with the second engagement member;
wherein the first engagement member includes a first raised portion, a first extension, and a first locking portion, wherein the first raised portion is adjacent to the elongated slot and is connected with the first plate and the second plate, a first end of the first extension is coupled with a bottom of the first raised portion, a second end of the first extension extends downward to connect with a first end of the first locking portion, and a second end of the first locking portion extends away from the first extension, wherein the first locking portion has a first groove defined on a surface thereof away from the elongated slot, and the first locking portion has a first notch defined on a bottom thereof, wherein a top of the first notch extends to the first notch;
wherein the second engagement member includes a second raised portion, a second extension, and a second locking portion, wherein the second raised portion is accommodated in the elongated slot, a first end of the second extension is coupled with a bottom of the second raised portion, a second end of the second extension extends downward to connect with a first end of the second locking portion, and a second end of the second locking portion extends away from the second extension, wherein the second locking portion has a second groove defined on a surface thereof away from the elongated slot, the second locking portion has a second notch defined on a bottom thereof, and a top of the second notch extends to the second;
wherein the screw rod inserts through the second raised portion and includes a coupling stem extending from an end thereof and rotatably connected with the first raised portion, wherein the screw rod further includes a rotatable portion connected with the coupling stem and located outside the base.

2. The repair tool as claimed in claim 1, wherein the base further includes an elongated slot, and the screw rod is accommodated in the elongated slot.

3. The repair tool as claimed in claim 2, wherein the base includes a first plate, a second plate, and at least one connection sheet, wherein the first and second plates are elongated, the first plate is parallelly opposite to the second plate, and the connection sheet is in connection with the first plate and the second plate, wherein the elongated slot of the base is defined between the first plate and the second plate.

4. The repair tool as claimed in claim 3, wherein the first raised portion is connected with the first plate and the second plate.

5. The repair tool as claimed in claim 1, wherein the rotatable portion is polygonal and has a polygonal orifice defined in a center of a distal end of the rotatable portion.

6. The repair tool as claimed in claim 1, wherein the coupling stem is retained with a fastening ring proximate to the first raised portion, and a washer is rotatably connected on the coupling stem between the first raised portion and the rotatable portion.
